(19) United States
(12) Patent Application Publication
(10) Pub. No.: US 2013/0278600 A1
(43) Pub. Date: Oct. 24, 2013

(54) RENDERING INTERACTIVE PHOTOREALISTIC 3D MODEL REPRESENTATIONS

(71) Applicants: Per Bloksgaard Christensen, Aarhus (DK); Thomas Teger, Orange, CA (US); Claus Wann Jensen, Silkeborg (DK); Henrik Wann Jensen, Solana Beacch, CA (US)

(72) Inventors: Per Bloksgaard Christensen, Aarhus (DK); Thomas Teger, Orange, CA (US); Claus Wann Jensen, Silkeborg (DK); Henrik Wann Jensen, Solana Beacch, CA (US)

(21) Appl. No.: 13/598,565

(22) Filed: Aug. 29, 2012

Related U.S. Application Data
(60) Provisional application No. 61/635,247, filed on Apr. 18, 2012.

(51) Int. Cl. G06T 17/00

(52) U.S. Cl. 345/420

(57) ABSTRACT

The present invention relates to a system, method, and apparatus that combine a novel specialized software program and a novel viewing program. The novel software program creates one or more photorealistic images of a 3D model at various camera angles. The novel viewing program allows the user to view the photorealistic images interactively directly on a web browser without third party proprietary software plugins. Also, the viewing program provides a novel approach to changing the colors of objects, by changing them dynamically.

### CROSS REFERENCE TO RELATED APPLICATIONS

This application claims priority under 35 U.S.C. §119(e) to U.S. Provisional Application No. 61/635,247, filed Apr. 18, 2012, and entitled “Rendering interactive photorealistic 3D model representations,” the disclosure of which is hereby incorporated by reference in its entirety.

### BACKGROUND OF THE INVENTION

1. Field of Invention

The present invention relates generally to a three-dimensional (3D) model in a computer rendering environment and specifically to a method, apparatus, and system for a specialized interactive and dynamic virtual reality representation of a 3D model using photorealistic rendering.

2. Description of Related Art

Virtual reality describes a range of experiences that lets a user interact with and explore a spatial environment through the user's computer. These spatial environments are typically computer renderings of simple or complex computer models.

A CAD program creates both 2D and 3D models. CAD is an important industrial art extensively used in many applications, including automotive, shipbuilding, and aerospace industries, industrial and architectural design, prosthetics, and many more. A derivative of CAD is also widely used to produce computer animation for special effects in movies, advertising, and technical manuals. The modern ubiquity and power of computers means that even perfume bottles and shampoo dispensers are designed using techniques unheard of by engineers of the 1960s. Because of its enormous economic importance, CAD has been a major driving force for research in computational geometry, computer graphics (both hardware and software), and discrete differential geometry. CAD is mainly used for detailed engineering of 3D models and/or 2D drawings of physical components, but it is also used throughout the design and engineering process from conceptual design and layout of products, through strength and dynamic analysis of assemblies to definition of manufacturing methods of components. It can also be used to design objects.

A virtual reality representation can be achieved using computer rendering such as a ray tracing program. One type of computer rendering is photorealistic rendering. The goal of photorealistic rendering is make the image looks like a photograph of the real object in the real world. Photorealistic rendering is the process of creating (i.e., rendering) an image of a 3D model from a computer aided design (CAD) program, that is, a 3D model representation.

Photorealistic rendering can be used to create an individual image or can be used to create an animation including multiple images. The individual image contains only one view of the 3D model, whereas the animation contains multiple views of the 3D model. For example, a turntable animation of a 3D model shows the model from different directions as the 3D model spins around on a virtual turntable.

A problem with photorealistic rendering is that it is a complex process that requires significant computation time. For example, it typically takes many hours to compute a photorealistic image of a 3D model. Similarly, it typically takes many days to compute an animation of a 3D model, because an animation involves rendering a large number of individual images of the 3D model.

One attempted solution for displaying photorealistic rendering interactively was Apple's QuickTime Virtual Reality (VR). Although Apple no longer supports QuickTime, QuickTime VR used to let a user interact with photographic representations of real locations. Apple's QuickTime VR allowed for a representation of a static object to be viewed from different discrete viewpoints. For example, QuickTime VR let the user rotate his view of a scene through a complete 360-degree horizontal circle. Multiple 360-degree views could have been linked together to let the user travel around in an area. The user could move around in space through as many points as the content developer provides. The content provider could also enable certain objects to be virtual as well, letting the user view all sides of an object by turning it around using a mouse. The combination of scenes and objects provided an experience that was like being there. As the user changed his view of the scene, the correct perspective was maintained, creating the effect of the user being at the location and looking around.

Although Apple's QuickTime VR showed different views of an object, the object was always static, and not dynamic. In other words, the user could not make any changes to the object or move the object. Additionally, Apple Quicktime VR required proprietary third party software to operate, such as a QuickTime plugin or a QuickTime player. That means Apple's Quicktime VR would not operate directly in a web browser, such as Internet Explorer, unless a specialized plugin was installed by the user.

U.S. Pat. No. 7,631,277 assigned to Apple, Inc. is directed to Apple's Quicktime VR. It discloses a system and method for integrating media objects for viewing on and manipulation via a computing device such as a personal computer. The system and method may be provided via an application program interface (API) which provides functions that allow an application program to create a scene and add media objects to the scene. The method includes preparing a translation vector and a rotation matrix for each of the media objects to define an orientation and a location of each of the media objects in the scene. The scene including the media objects is displayed. An interface is provided so that a user may manipulate the scene and the objects therein. The system and method may be implemented on a personal computer or other computing device. However, Apple's system does not disclose a dynamic representation of a 3D model or a system that can operate directly into a web browser.

### SUMMARY OF THE INVENTION

Embodiments of the present invention relate to a system, method, and apparatus that combine a novel specialized software program and a novel viewing program. The novel software program creates one or more images of a 3D model at various camera angles. The novel viewing program allows the photorealistic images to be viewed interactively directly on a webpage/web browser without third party proprietary software plugins. Also, the viewing program provides a novel approach to changing the colors of objects, by changing them dynamically.

An advantage of the present invention is that the viewing system does not require third party software plugins. Thus, the photorealistic images can be loaded directly onto a webpage. Another advantage is the specialized software program relies on pre-rendered specialized images that can be loaded much faster than the time it takes to render a photorealistic image. Further, the specialized software program can use progressive loading such that the user can see and interact with the images that have been loaded—thereby allowing for even faster use of an animated 3D model.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 illustrates a virtual reality system for creating a specialized photorealistic rendering of a 3D model according to one embodiment of the invention.

FIG. 2 illustrates a CAD program of the system according to one embodiment of the invention.

FIG. 3 illustrates a ray tracing program of the system according to one embodiment of the invention.

FIG. 4 illustrates a viewing program of the system according to one embodiment of the invention.

FIG. 5 illustrates a flow chart showing a process for photorealistic rendering of a 3D model according to one embodiment of the invention.

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

The present invention relates to a novel method, system, and apparatus creating images of a 3D model imported from any CAD system to a ray tracing program. The ray tracing program enables interactive and dynamic presentations of the 3D model. The user immediately sees the effect of changes applied to the 3D model such as lighting changes, material changes, and model movements. The ray tracing application uses progressive rendering to provide rapid feedback to the user.

The invention combines two novel technologies. First, the system uses a specialized software program. The specialized software program allows for editing the 3D model, the materials, lighting, and animation of photorealistic images representing the 3D model to obtain a desired appearance and movement a given 3D model. Second, the system uses a unique viewer (e.g., a viewing program). The viewer can take rendered images from the ray tracing program and use these to produce novel views and interactive representations of the 3D model. The viewer can be implemented without the need for a proprietary or third party software plugin, so it can run directly in any modern web browser such as Internet Explorer, Firefox, Safari, or Chrome.

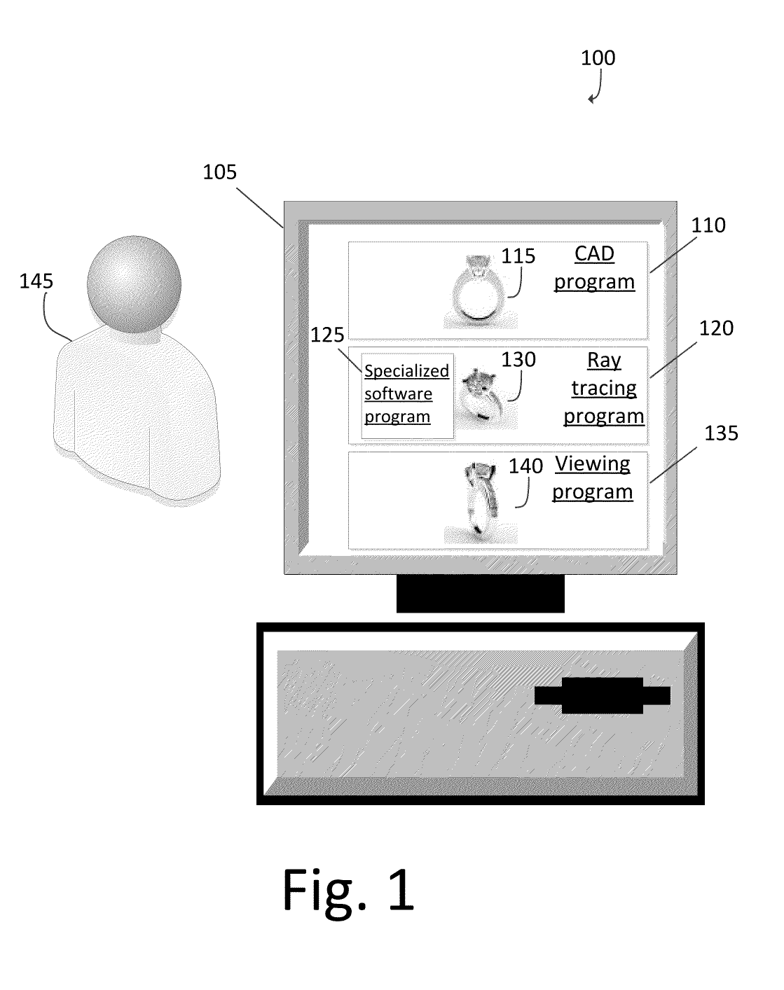

FIG. 1 illustrates a virtual reality system 100 for creating a specialized photorealistic rendering of a 3D model according to one embodiment of the invention. The system 100 includes a terminal 105, a CAD program 110 for creating a 3D model 115, a ray tracing program 120 having a specialized software program 125 for creating one or more photorealistic images 130 of the 3D model 115, a viewing program 135 having one or more specialized photorealistic images 140 of the model 115, and a user 145. The system 100 creates the specialized photorealistic images 140 of the 3D model 115 for dynamic and interactive interactions.

The terminal 105 comprises hardware, software, and a screen for the user 145. The user 145 can create, edit, or interact with the CAD program 110, the ray tracing program 120, and the viewing program 135 on the screen of the terminal 105. The hardware comprises a processor and memory, and a graphics card for viewing purposes. The processor can be used to create and interact with the specialized photorealistic images 140.

The CAD program 110 can be any conventional CAD system. CAD is the use of computer technology for the process of design and design-documentation computer aided drafting. CAD may be used to design curves, surfaces, solids, and figures in two-dimensional (2D) space and three-dimensional (3D) space.

The 3D model 115 (e.g., CAD model, model, object, etc.) includes characteristics such as shapes, colors, materials, animation, processes, dimensions, and tolerances, and part names. The 3D model 115 is a digital 3D representation of a given object as well as other parameters. The 3D model 115 is illustrated as a diamond ring. However, the 3D model 115 can be any object created in CAD, such as, for example, a car, a bike, a watch, etc.

The ray tracing program 120 (e.g., interactive 3D ray tracing environment, ray tracing application, 3D rendering system, etc.) continuously renders one or more images based on the characteristics of the 3D model 115 in the CAD program 110. The ray tracing program allows for interactive assignment of materials, set up of lighting environments, and camera angles. The ray tracing program 120 allows a ray traced view of the 3D model 115 in an interactive 3D ray tracing environment. The ray tracing program 120 also shows the 3D model's encounters with other virtual objects.

In general, ray tracing is a technique in computer graphics for generating an image by tracing the path of light through pixels in an image plane and simulating the effects of its encounters with virtual objects. The technique is capable of producing a very high degree of visual realism, usually higher than that of typical scanline rendering methods, but at a greater computational cost. This makes ray tracing best suited for applications where the image can be rendered slowly ahead of time, such as in still images and film and television special effects, and more poorly suited for real-time applications like video games where speed is critical. Ray tracing is capable of simulating a wide variety of optical effects, such as reflection and refraction, scattering, and dispersion phenomena (such as chromatic aberration).

The specialized software program 125 creates one or more photorealistic images 130 of the 3D model 115. The photorealistic images 130 (e.g., virtual reality representation of the 3D model 115, interactive and dynamic representation, etc.) are rendered using photorealistic rendering, where the goal of photorealistic rendering is to create an image of the 3D model 115 that looks like a photograph of the real object in the real world. The photorealistic images include a plurality of animation sequences. The number of photorealistic images 130 corresponds to the number of desired frames in the animation.

The specialized software 125 improves on conventional methods because it provides a full application pipeline capable of taking as input a CAD model and applies materials and lighting necessary for generating the photorealistic views required by the viewing application. Furthermore, the ray tracing application 120 can directly create a webpage with a fully dynamic view of a 3D model that a user can spin around and zoom into.

The software 125 can be consider “specialized” because it allows for editing materials, lighting, and animation of photorealistic images representing the 3D model to obtain a desired appearance and movement a given 3D model, and at the same time outputs a complete interactive representation that can be viewed in a webbrowser.

Furthermore, the user 145 can optionally change the color of the model, animate the model, change geometric parts of the model, and change the lighting. The ray tracing application 120 will create the images necessary for the viewing program 135 to provide the full flexibility specified by a user. This process is not available today. While it is possible to create images and animations from CAD models, it is necessary to use third-party software to assemble these images into something that can be viewed on a webpage. This is a difficult process as it requires the user to render all the views of the model that are needed by the third-party application, and furthermore existing third-party applications are limited to simple views of 3D models. This is due to the fact that the third-party applications only operate on images and they do not have the knowledge of the 3D model that the ray tracing program 120 has.

The software program 125 directly creates the photorealistic images 130 of 3D model 115 which are transmitted to the viewing program 135 such that they can be viewed and interacted with on a webpage. This is an important improvement over conventional software packages which allow the user to take an existing set of images and prepare a conventional 3D model viewer. These conventional software packages only operate on images, not animations, 3D models, or CAD models. Additionally, conventional software packages have a complex and time consuming process for generating those images. Furthermore, the conventional software packages are limited to basic viewing. The specialized software program 125 contains the full pipeline, from loading the raw 3D CAD model, to making it look photorealistic, and then to outputting a representation (e.g., such as a webpage) directly to allow interactive viewing and other changes.

The specialized software program 125 further optimizes the web-based experience of the viewer by including progressive loading. Progressive loading makes it possible for the user 145 to interact with the 3D model 115 before the entire data representation is transferred to the viewing program 135. This progressive loading means that the user 145 can get a coarse representation (e.g., a few views) quickly after loading just a fraction of the specialized photorealistic images 140.

The viewing program 135 (e.g., viewer, viewing applications, etc.) shows the one or more specialized photorealistic images 140 of the model 115. The viewing program 135 allows the user 145 to dynamically view and interact with the photorealistic images 140 on a webpage. The photorealistic images 140 can also be loaded onto a media device such as a tablet computer for subsequent viewing and interaction. The viewing program 135 can be described as lightweight, which means that it is easily deployable and does not exhaust significant system resources.

The viewing program 135 is unique over conventional methods because it does not require plugins. It can be created directly by the ray tracing application 120 as part of a webpage (e.g., using Javascript). The viewing applications 135 are optimized for viewing 3D models over slow network connections as it loads the images progressively such as views of different sides of the model are loaded first making it possible for the user to quickly navigate around a coarse representation of the model. Furthermore, the viewing program 135 can use specialized images from the ray tracing application 120 to add extra functionality such as changing the color of an object while still being able to rotate and zoom into the object.

A viewing program that can change the color of an object dynamically is a unique piece of technology by itself. The viewing program 135 can change the color of a static image and a dynamic animation. The ability to change the color of an object or part of an object dynamically is achieved by rendering two sets of images in the ray tracing application 120. One image is the base image rendered as if the object/part is completely black. The second image is a grayscale image, where every pixel shows only the contribution of the object/part as if it was perfectly white. In the second image, all other objects are invisible (black) except for the parts that are affected by the color being changed. This can be due to the part being directly visible or visible in a reflection or through another object. The viewing application can create the appearance of an arbitrary color of the 3D object being viewed by adding the two images such that the second image is multiplied by the desired object color and then added to the first image. This sum is displayed by the viewing application 135. Note, that this is a completely novel approach to changing colors of objects dynamically.

The viewer 135 can be consider “specialized” because the viewer can be implemented without the need for a proprietary or third party software plugin, so it can run directly in any modern web browser such as Internet Explorer, Firefox, Safari, or Chrome.

The photorealistic images 140 (e.g., specialized virtual reality representation of the 3D model 115, interactive and dynamic representation, rendering interactive photorealistic 3D model representations, etc.) are a specialized representation of the 3D model 115 rendered from the specialized software program 125. The photorealistic images 130 and 140 can be considered the same image, where the photorealistic images 130 are created by the ray tracing program before being output to the viewer 135 and the photorealistic images 140 have already been created by the ray tracing program and stored in a format that the viewing application can process.

The photorealistic images 140 are output from the ray tracing application 120 to the viewer 135. The output from the ray tracing application 120 can be a complete HTML page that can be directly uploaded to a webserver, which makes it significantly easier for the user 145 to publish dynamic 3D models on the web. For example, the specialized photorealistic images 140 can include images, an HTML page and a corresponding JavaScript code that makes it possible to directly view the 3D model 115 in a web browser such as Internet Explorer.

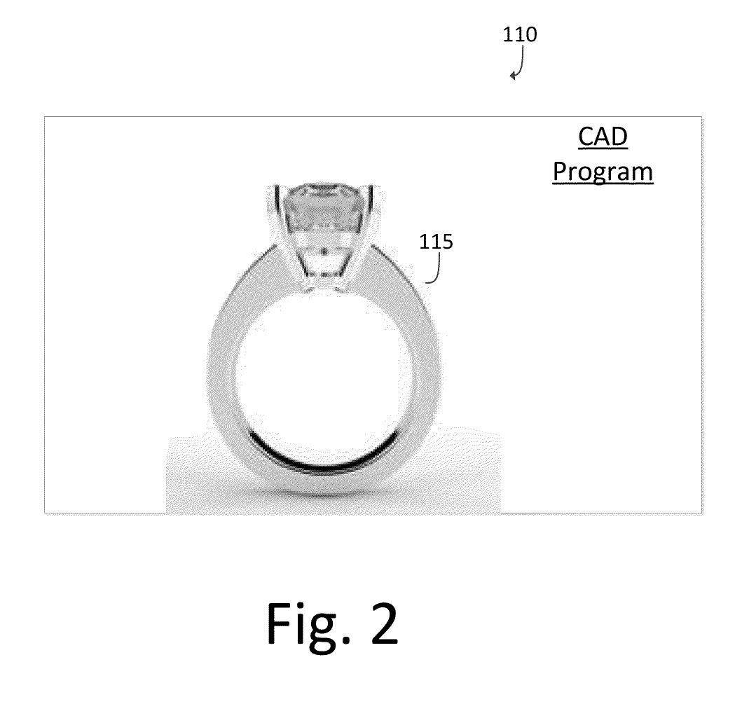

FIG. 2 illustrates the CAD program 110 of the system 100 according to one embodiment of the invention. The 3D model 115 is a diamond ring. In another embodiment, the 3D model 115 is another object such as a car, bike, watch, etc.

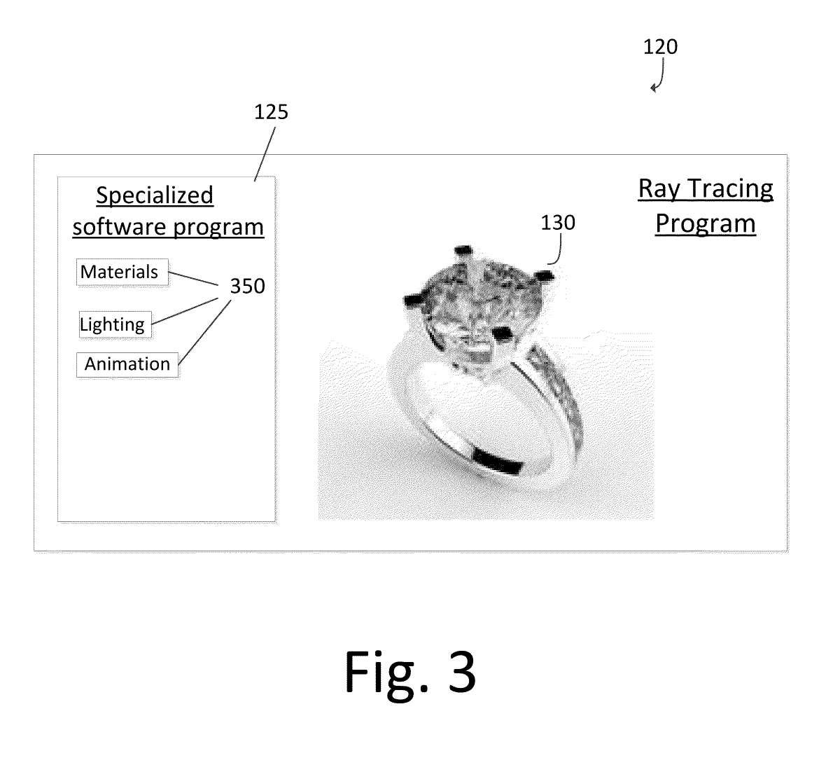

FIG. 3 illustrates the ray tracing program 120 of the system 100 according to one embodiment of the invention. The ray tracing program 120 includes one or more photorealistic images 130 of the 3D model 115. Photorealistic images give a 3D representation of a given object. The goal of photorealistic rendering is to create an image of the 3D model 115 that looks like a photograph of the real object in the real world. The illustrated diamond ring is an animation, meaning there are several views, where a top perspective view is shown.

The ray tracing program 120 can read the native or a neutral file format generated by the CAD program 110, or ray tracing program 120 can be directly connected the CAD program 110.

The ray tracing program includes the software program 125 configured to create one or more photorealistic images 130 of the 3D model 115 and to interactively change the 3D model 115 including materials and lighting to achieve a given appearance in the rendered images; and a viewing application that uses the specialized images output by the ray tracing program. The specialized software program 125 includes visual characteristics 350. The visual characteristics 350 allow the specialized software program 125 to edit the photorealistic image 130. The visual characteristics can include, for example, materials, lighting, and animation.

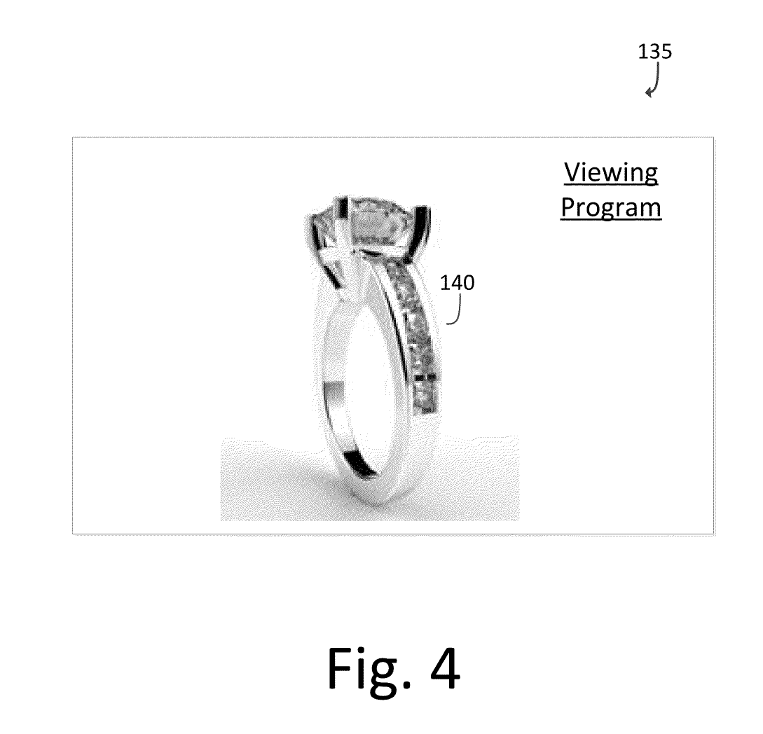

FIG. 4 illustrates the viewing program 135 of the system 100 according to one embodiment of the invention. If the ray tracing program 120 created more than one image for the 3D model 115, multiple photorealistic images 140 of the 3D model 115 allow the user 145 to see multiple views of the 3D model 115.

The illustrated diamond ring is shown from a side perspective view. In one embodiment, the user 145 uses his left mouse button to move the photorealistic images 140 of 3D model 115 around once the photorealistic images 140 are loaded. The user 145 can also make changes to the colors and other changes to the 3D model 115 in the viewer program 135. In a progressive loading embodiment, the user 145 can move the photorealistic images 140 of 3D model 115 around before all of the photorealistic images of the 3D model 115 have finished loading.

The connection between the ray tracing application 120 and the viewing application 135 is mainly due to the fact that they both “know each other.” This makes it very easy for the user 145 to control the entire viewing and/or presentation experience from within the ray tracing application 120. Also, the final quality output on the viewer 135, which is fully ray traced, is of much higher quality than existing technologies based around Virtual Reality Modeling Language (VRML).

The specialized photorealistic images 140 (e.g., representation of the 3D model 115) can be used directly for interactive and dynamic interaction with the photorealistic images 130 of 3D model 115 outputted from the interactive ray traced view. The output can be viewed directly in a web browser and can contain JavaScript. The output can also be progressively loaded to allow for quick interaction, where the interaction improves as the remaining data is loaded. The output can also allow for playback of multiple different animation sequences, color changes on the 3D model 115, and other 3D model 115 changes. The output allows for horizontal rotations including linear and 360 degrees, and possible vertical rotations including linear and 360 degrees, with the ability to set the starting point of the rotation.

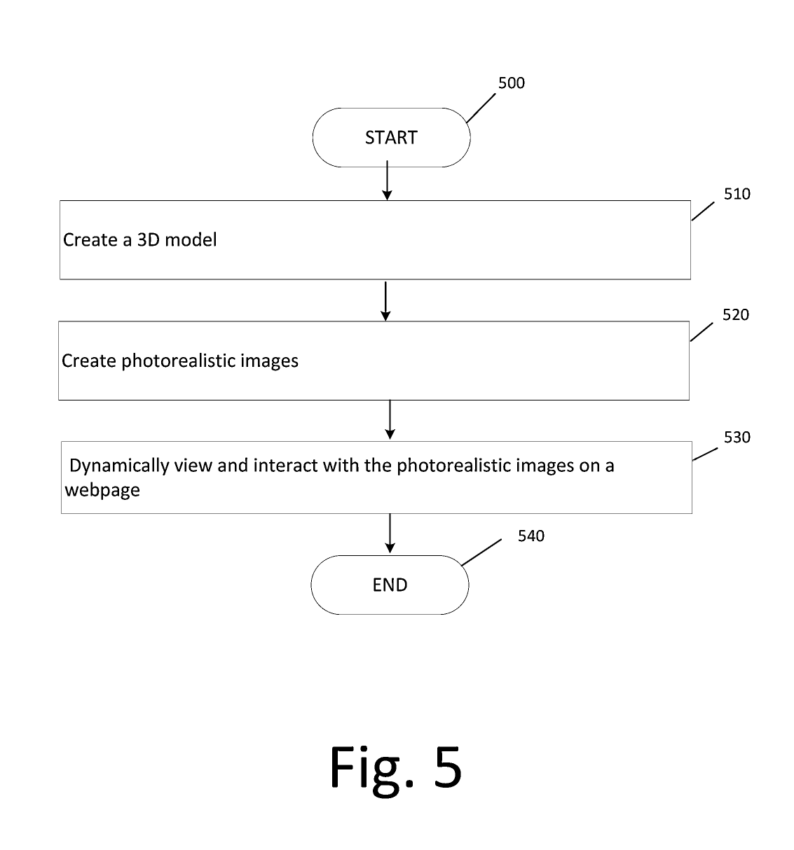

FIG. 5 illustrates a flow chart showing a process for photorealistic rendering of the 3D model 115 according to one embodiment of the invention. The process starts at step 500. At step 510, the CAD program 110 creates the 3D model 115. The user 145 can load the 3D model 115 into the ray tracing program 120. Next, at step 520, the ray tracing program 120 creates the one or more photorealistic images 130. A specialized software program allows the user 145 to assign visual characteristics to the photorealistic images 130, such as materials, lighting, and possible animations to get the desired appearance and behavior for the 3D model 115. The ray tracing program 120 can create one image for a single view or create multiple images for multiple animation views. The user 145 can also pick a desired starting camera angle of the 3D model 115. For an animation, the user 145 can specify how the 3D model 115 should be viewed (e.g., turntable view only, full spherical view, etc.).

At step 530, the viewing program 135 allows the user 145 to dynamically view and interact with the photorealistic images 140 on a webpage. The viewing program can receive specialized photorealistic images 140, which is a specialized representation of the 3D model 115 rendered from the specialized software program 125. The specialized photorealistic images 140 can include images, an HTML page and a corresponding JavaScript code that makes it possible to directly view the 3D model 115 in a web browser such as Internet Explorer. The process ends at step 540.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

It should be understood that the invention is not limited to the embodiments set forth herein for purposes of exemplification, but is to be defined only by a fair reading of the appended claims, including the full range of equivalency to which each element thereof is entitled. Although the invention has been described with reference to the above examples, it will be understood that modifications and variations are encompassed within the spirit and scope of the invention. Accordingly, the invention is limited only by the following claims.

What is claimed is:

1. A system comprising:
a computer aided design (CAD) program creating a three dimensional (3D) CAD model;
a ray tracing program comprising a software program, the software program configured to load CAD files and to create, output, and dynamically interact with one or more photorealistic images of the 3D CAD model; and
a viewing program that directly interacts with the output from the ray tracing program, the viewing program configured to dynamically view and interact with the photorealistic images of the 3D model directly on a web browser.

2. The system of claim 1, wherein the photorealistic images directly interact with the 3D model.

3. The system of claim 1, wherein the output is progressively loaded, wherein progressive loading allows for interaction before all data is loaded and the interaction improves as more data is loaded.

4. The system of claim 1, wherein the output comprises JavaScript.

5. The system of claim 1, wherein the output represents each view as the sum of a first image and a second image, where the first image is multiplied by a desired color and added to the second image to allow for color changes on the 3D model.

6. The system of claim 1, wherein the direct interaction of the viewing program with the output allows for changes to the 3D model.

7. The system of claim 1, wherein the direct interaction of the viewing program with the output allows for horizontal rotations including linear and 360 degrees, vertical rotations including linear and 360 degrees, and the ability to set a starting point for a rotation.

8. The system of claim 1, wherein the viewing program allows a user to zoom in on the photorealistic images and obtain higher resolution views.

9. The system of claim 1, wherein CAD program allows the user to replace parts, replace materials, and change the lighting of the 3D model.

10. The system of claim 1, wherein the viewing program is opened as part of the web browser and the viewing program is opened directly by the ray tracing program.

11. A method comprising:
creating a three dimensional (3D) computer aided design (CAD) model;
loading CAD files into a ray tracing program, the ray tracing program allowing a user to create, output, and dynamically interact with one or more photorealistic images of the 3D CAD model; and
using a viewing program to interact directly with the output from the ray tracing program, wherein the viewing program is configured to dynamically view and interact with the photorealistic images of the 3D model directly on a web browser.
